(19) United States
(12) Patent Application Publication
(10) Pub. No.: US 2013/0114495 A1
(43) Pub. Date: May 9, 2013

(54) Physical Channel Characteristics for e-PDCCH in LTE

(71) Applicant: QUALCOMM Incorporated, San Diego, CA (US)

(72) Inventors: Wanshi Chen, San Diego, CA (US); Stefan Geirhofer, San Diego, CA (US); Tao Luo, San Diego, CA (US); Peter Gaal, San Diego, CA (US); Hao Xu, San Diego, CA (US); Juan Montojo, San Diego, CA (US); Jelena M. Damnjanovic, San Diego, CA (US)

(73) Assignee: QUALCOMM INCORPORATED, San Diego, CA (US)

(21) Appl. No.: 13/666,042

(22) Filed: Nov. 1, 2012

Related U.S. Application Data
(60) Provisional application No. 61/707,176, filed on Sep. 28, 2012.
(60) Provisional application No. 61/679,664, filed on Aug. 3, 2012.
(60) Provisional application No. 61/556,136, filed on Nov. 4, 2011.

(51) Int. Cl. H04W 72/06; H04W 4/06

(52) U.S. Cl. 370/312; 370/329

(57) ABSTRACT

Certain aspects of the present disclosure provide techniques for processing and transmitting enhanced physical downlink control channel (PDCCH) transmissions.

### CLAIM OF PRIORITY UNDER 35 U.S.C. §119

This application claims benefit of U.S. Provisional Patent Application Ser. No. 61/707,176, filed Sep. 28, 2012, which is herein incorporated by reference in its entirety, U.S. Provisional Patent Application Ser. No. 61/679,664, filed Aug. 3, 2012, which is herein incorporated by reference in its entirety, and U.S. Provisional Patent Application Ser. No. 61/556,136, filed Nov. 4, 2011, which is herein incorporated by reference in its entirety.

### BACKGROUND

1. Field

Aspects of the present disclosure relate generally to wireless communication systems, and more particularly, to physical channel characteristics for e-PDCCH in LTE.

2. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station. The base station may send a Physical Downlink Control Channel (PDCCH). The PDCCH may carry information on uplink and downlink resource allocation for UEs and power control information for uplink channels.

### SUMMARY

Certain aspects of the present disclosure provide techniques and corresponding apparatus and computer program products for wireless communications.

Certain aspects of the present disclosure provide a method for wireless communication by a user equipment (UE). The method generally includes determining a transmission rank for an enhanced physical downlink control channel (PDCCH) transmission, determining one or more antenna ports used for the enhanced PDCCH, determining a rate matching scheme for the enhanced PDCCH, wherein rate matching is performed around at least one of a channel state information reference signal (CSI-RS) or a common reference signal (CRS), and processing the enhanced PDCCH transmitted in accordance with the determined transmission rank, the determined one or more antenna ports, and the determined rate matching scheme.

Certain aspects of the present disclosure provide an apparatus for wireless communication by a user equipment (UE). The apparatus generally includes means for determining a transmission rank for an enhanced physical downlink control channel (PDCCH) transmission, means for determining one or more antenna ports used for the enhanced PDCCH, means for determining a rate matching scheme for the enhanced PDCCH, wherein rate matching is performed around at least one of a channel state information reference signal (CSI-RS) or a common reference signal (CRS), and means for processing the enhanced PDCCH transmitted in accordance with the determined transmission rank, the determined one or more antenna ports, and the determined rate matching scheme.

Certain aspects of the present disclosure provide an apparatus for wireless communication by a user equipment (UE). The apparatus generally includes at least one processor configured to determine a transmission rank for an enhanced physical downlink control channel (PDCCH) transmission, determine one or more antenna ports used for the enhanced PDCCH, determine a rate matching scheme for the enhanced PDCCH, wherein rate matching is performed around at least one of a channel state information reference signal (CSI-RS) or a common reference signal (CRS), and process the enhanced PDCCH transmitted in accordance with the determined transmission rank, the determined one or more antenna ports, and the determined rate matching scheme; and a memory coupled with the at least one processor.

Certain aspects of the present disclosure provide a computer program product for wireless communications by a user equipment (UE) comprising a computer readable medium having instructions stored thereon. The instructions are generally executable by one or more processors for determining a transmission rank for an enhanced physical downlink control channel (PDCCH) transmission, determining one or more antenna ports used for the enhanced PDCCH, determining a rate matching scheme for the enhanced PDCCH, wherein rate matching is performed around at least one of a channel state information reference signal (CSI-RS) or a common reference signal (CRS), and processing the enhanced PDCCH transmitted in accordance with the determined transmission rank, the determined one or more antenna ports, and the determined rate matching scheme.

Certain aspects of the present disclosure provide a method for wireless communication by a base station. The method generally includes determining a transmission rank for an enhanced physical downlink control channel (PDCCH) transmission, determining one or more antenna ports used for the enhanced PDCCH transmission, determining a rate matching scheme for the enhanced PDCCH, wherein rate matching is performed around at least one of a channel state information reference signal (CSI-RS) or a common reference signal (CRS), and transmitting the enhanced PDCCH to a user equipment (UE) in accordance with the determined transmission rank, the determined one or more antenna ports, and the determined rate matching scheme.

Certain aspects of the present disclosure provide an apparatus for wireless communication by a base station. The apparatus generally includes means for determining a transmission rank for an enhanced physical downlink control channel (PDCCH) transmission, means for determining one or more antenna ports used for the enhanced PDCCH transmission, means for determining a rate matching scheme for the enhanced PDCCH, wherein rate matching is performed around at least one of a channel state information reference signal (CSI-RS) or a common reference signal (CRS), and means for transmitting the enhanced PDCCH to a user equipment (UE) in accordance with the determined transmission rank, the determined one or more antenna ports, and the determined rate matching scheme.

Certain aspects of the present disclosure provide an apparatus for wireless communication by a base station. The apparatus generally includes at least one processor configured to determine a transmission rank for an enhanced physical downlink control channel (PDCCH) transmission, determine one or more antenna ports used for the enhanced PDCCH transmission, determine a rate matching scheme for the enhanced PDCCH, wherein rate matching is performed around at least one of a channel state information reference signal (CSI-RS) or a common reference signal (CRS), and transmit the enhanced PDCCH to a user equipment (UE) in accordance with the determined transmission rank, the determined one or more antenna ports, and the determined rate matching scheme.

Certain aspects of the present disclosure provide a computer program product for wireless communications by a base station comprising a computer readable medium having instructions stored thereon. The instructions are generally executable by one or more processors for determining a transmission rank for an enhanced physical downlink control channel (PDCCH) transmission, determining one or more antenna ports used for the enhanced PDCCH transmission, determining a rate matching scheme for the enhanced PDCCH, wherein rate matching is performed around at least one of a channel state information reference signal (CSI-RS) or a common reference signal (CRS), and transmitting the enhanced PDCCH to a user equipment (UE) in accordance with the determined transmission rank, the determined one or more antenna ports, and the determined rate matching scheme.

### BRIEF DESCRIPTION OF THE DRAWINGS

FIG. 1 is a block diagram conceptually illustrating an example of a telecommunications system;

FIG. 2 is a block diagram conceptually illustrating an example of a down link frame structure in a telecommunications system;

FIG. 3 is a block diagram conceptually illustrating a design of a base station/eNodeB and a UE configured according to one aspect of the present disclosure;

FIG. 4A illustrates a continuous carrier aggregation type;

FIG. 4B illustrates a non-continuous carrier aggregation type;

FIG. 5 illustrates MAC layer data aggregation; and

FIG. 6 is a block diagram illustrating a method for controlling radio links in multiple carrier configurations.

FIG. 7 illustrates possible structures for e-PDCCH 700, according to aspects of the present disclosure.

FIG. 8 illustrates an example double RI reporting structure for CSI feedback, according to certain aspects of the present disclosure.

FIG. 9 illustrates example operations 900 that may be performed by a user equipment (UE), according to certain aspects of the present disclosure.

FIG. 10 illustrates example operations 1000 that may be performed by a base station, according to certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

### An Example Wireless Communications System

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

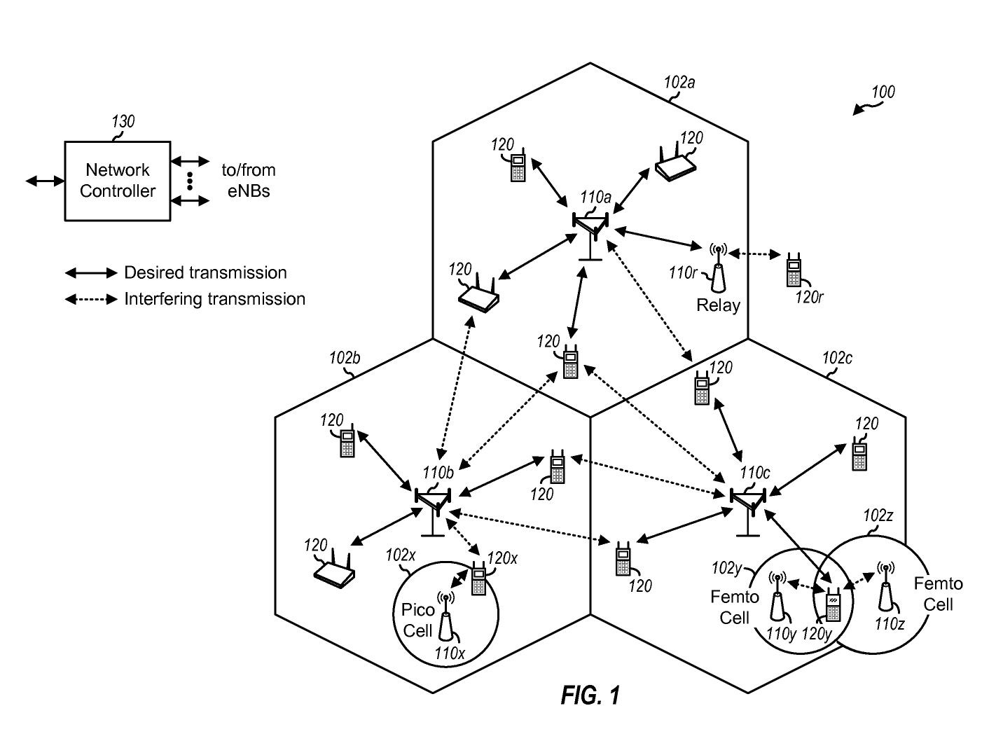

FIG. 1 shows a wireless communication network 100, which may be an LTE network. The wireless network 100 may include a number of evolved Node Bs (eNodeBs) 110 and other network entities. An eNodeB 110 may be a station that communicates with the user equipments (UEs) 12-0 and may also be referred to as a base station, an access point, etc. A Node B is another example of a station that communicates with the UEs.

Each eNodeB 110 may provide communication coverage for a particular geographic area. In 3GPP, the term “cell” can refer to a coverage area of an eNodeB 110 and/or an eNodeB subsystem serving this coverage area, depending on the context in which the term is used.

An eNodeB 110 may provide communication coverage for a macro cell 102a, 102b, 102c, a pico cell 102x, a femto cell 102y, 102z, and/or other types of cell. A macro cell 102a, 102b, 102c may cover a relatively large geographic area (e.g., several kilometers in radius) and may allow unrestricted access by UEs 120 with service subscription. A pico cell 102x may cover a relatively small geographic area and may allow unrestricted access by UEs 120c with service subscription. A femto cell 102y, 102z may cover a relatively small geographic area (e.g., a home) and may allow restricted access by UEs 120 having association with the femto cell 102y, 102z (e.g., UEs in a Closed Subscriber Group (CSG), UEs for users in the home, etc.). An eNodeB 110 for a macro cell 102a, 102b, 102c may be referred to as a macro eNodeB. An eNodeB 110 for a pico cell 102x may be referred to as a pico eNodeB. An eNodeB 110 for a femto cell 102y, 102z may be referred to as a femto eNodeB or a home eNodeB. In the example shown in FIG. 1, the eNodeBs 110a, 110b and 110c may be macro eNodeBs for the macro cells 102a, 102b and 102c, respectively. The eNodeB 110x may be a pico eNodeB for a pico cell 102x. The eNodeBs 110y and 110z may be femto eNodeBs for the femto cells 102y and 102z, respectively. An eNodeB 110 may support one or multiple (e.g., three) cells.

The wireless network 100 may also include relay stations 110r, 110x, 110y, 110z. A relay station is a station that receives a transmission of data and/or other information from an upstream station (e.g., an eNodeB 110 or a UE 120) and sends a transmission of the data and/or other information to a downstream station (e.g., a UE 120 or an eNodeB 110). A relay station may also be a UE that relays transmissions for other UEs. In the example shown in FIG. 1, a relay station 110r may communicate with the eNodeB 110a and a UE 120r in order to facilitate communication between the eNodeB 110a and the UE 120r. A relay station may also be referred to as a relay eNodeB, a relay, etc.

The wireless network 100 may be a heterogeneous network that includes eNodeBs of different types, e.g., macro eNodeBs, pico eNodeBs, femto eNodeBs, relays, etc. These different types of eNodeBs may have different transmit power levels, different coverage areas, and different impact on interference in the wireless network 100. For example, macro eNodeBs may have a high transmit power level (e.g., 20 Watts) whereas pico eNodeBs, femto eNodeBs and relays may have a lower transmit power level (e.g., 1 Watt).

The wireless network 100 may support synchronous or asynchronous operation. For synchronous operation, the eNodeBs may have similar frame timing, and transmissions from different eNodeBs may be approximately aligned in time. For asynchronous operation, the eNodeBs may have different frame timing, and transmissions from different eNodeBs may not be aligned in time. The techniques described herein may be used for both synchronous and asynchronous operation.

A network controller 130 may couple to a set of eNodeBs 110 and provide coordination and control for these eNodeBs. The network controller 130 may communicate with the eNodeBs 110 via a backhaul. The eNodeBs 110 may also communicate with one another, e.g., directly or indirectly via wireless or wireline backhaul.

The UEs 120 may be dispersed throughout the wireless network 100, and each UE 120 may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, etc. A UE may be able to communicate with macro eNodeBs, pico eNodeBs, femto eNodeBs, relays, etc. In FIG. 1, a solid line with double arrows indicates desired transmissions between a UE and a serving eNodeB, which is an eNodeB designated to serve the UE on the downlink and/or uplink. A dashed line with double arrows indicates interfering transmissions between a UE and an eNodeB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a ‘resource block’) may be 12 subcarriers (or 180 kHz). Consequently, the nominal FFT size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

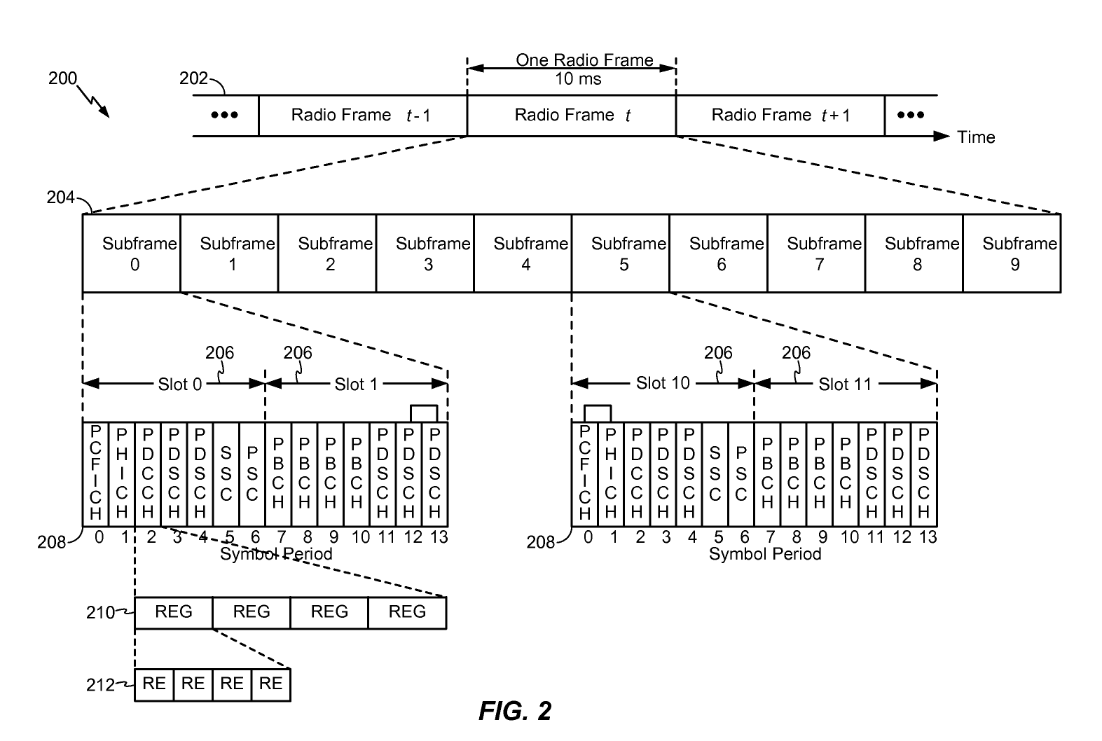

FIG. 2 shows a down link frame structure 200 used in LTE. The transmission timeline for the downlink may be partitioned into units of radio frames 202. Each radio frame may have a predetermined duration (e.g., 10 milliseconds (ms)) and may be partitioned into 10 sub-frames 204 with indices of 0 through 9. Each sub-frame may include two slots 206. Each radio frame may thus include 20 slots with indices of 0 through 19. Each slot may include L symbol periods 208, e.g., 7 symbol periods 208 for a normal cyclic prefix (as shown in FIG. 2) or 14 symbol periods 208 for an extended cyclic prefix. The 2 L symbol periods 208 in each sub-frame 204 may be assigned indices of 0 through 2 L-1. The available time frequency resources may be partitioned into resource blocks. Each resource block may cover N subcarriers (e.g., 12 subcarriers) in one slot.

In LTE, an eNodeB 110 may send a primary synchronization signal (PSS) and a secondary synchronization signal (SSS) for each cell in the eNodeB. The primary and secondary synchronization signals may be sent in symbol periods 6 and 5, respectively, in each of sub-frames 0 and 5 of each radio frame with the normal cyclic prefix, as shown in FIG. 2. The synchronization signals may be used by UEs 120 for cell detection and acquisition. The eNodeB 110 may send a Physical Broadcast Channel (PBCH) in symbol periods 0 to 3 in slot 1 of sub-frame 0. The PBCH may carry certain system information.

The eNodeB 110 may send a Physical Control Format Indicator Channel (PCFICH) in only a portion of the first symbol period 208 of each sub-frame 204, although depicted in the entire first symbol period 0 in FIG. 2. The PCFICH may convey the number of symbol periods (M) used for control channels, where M may be equal to 1, 2 or 3 and may change from sub-frame to sub-frame. M may also be equal to 4 for a small system bandwidth, e.g., with less than 10 resource blocks. In the example shown in FIG. 2, M=3. The eNodeB 110 may send a Physical HARQ Indicator Channel (PHICH) and a Physical Downlink Control Channel (PDCCH) in the first M symbol periods of each sub-frame (M=3 in FIG. 2). The PHICH may carry information to support hybrid automatic retransmission (HARQ). The PDCCH may carry information on uplink and downlink resource allocation for UEs 120 and power control information for uplink channels. Although not shown in the first symbol period 208 (0) in FIG. 2, it is understood that the PDCCH and PHICH are also included in the first symbol period 208 (0). Similarly, the PHICH and PDCCH are also both in the second and third symbol periods 208 (1), 208 (2), although not shown that way in FIG. 2. The eNodeB 110 may send a Physical Downlink Shared Channel (PDSCH) in the remaining symbol periods of each sub-frame 204. The PDSCH may carry data for UEs 120 scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNodeB 110 may send the PSS, SSS and PBCH in the center 1.08 MHz of the system bandwidth used by the eNodeB 110. The eNodeB 110 may send the PCFICH and PHICH across the entire system bandwidth in each symbol period 208 in which these channels are sent. The eNodeB 110 may send the PDCCH to groups of UEs 120 in certain portions of the system bandwidth. The eNodeB 110 may send the PDSCH to specific UEs 120 in specific portions of the system bandwidth. The eNodeB 110 may send the PSS, SSS, PBCH, PCFICH and PHICH in a broadcast manner to all UEs 120, may send the PDCCH in a unicast manner to specific UEs 120, and may also send the PDSCH in a unicast manner to specific UEs 120.

A number of resource elements (REs) 212 may be available in each symbol period 208. Each resource element 212 may cover one subcarrier in one symbol period 208 and may be used to send one modulation symbol, which may be a real or complex value. Resource elements 212 not used for a reference signal (RS) in each symbol period 208 may be arranged into resource element groups (REGs) 210. Each REG 210 may include four REs 212 in one symbol period 208. The PCFICH may occupy four REGs 210, which may be spaced approximately equally across frequency, in symbol period 0. The PHICH may occupy three REGs 210, which may be spread across frequency, in one or more configurable symbol periods 208. For example, the three REGs 210 for the PHICH may all belong in symbol period 0 or may be spread in symbol periods 0, 1 and 2. The PDCCH may occupy 9, 18, 32 or 64 REGs, which may be selected from the available REGs 210, in the first M symbol periods. Only certain combinations of REGs 210 may be allowed for the PDCCH.

A UE 120 may know the specific REGs 210 used for the PHICH and the PCFICH. The UE 120 may search different combinations of REGs 210 for the PDCCH. The number of combinations to search is typically less than the number of allowed combinations for the PDCCH. An eNodeB 110 may send the PDCCH to the UE 120 in any of the combinations that the UE 120 will search.

A UE 120 may be within the coverage of multiple eNodeBs. One of these eNodeBs 110 may be selected to serve the UE 120. The serving eNodeB 110 may be selected based on various criteria such as received power, path loss, signal-to-noise ratio (SNR), etc.

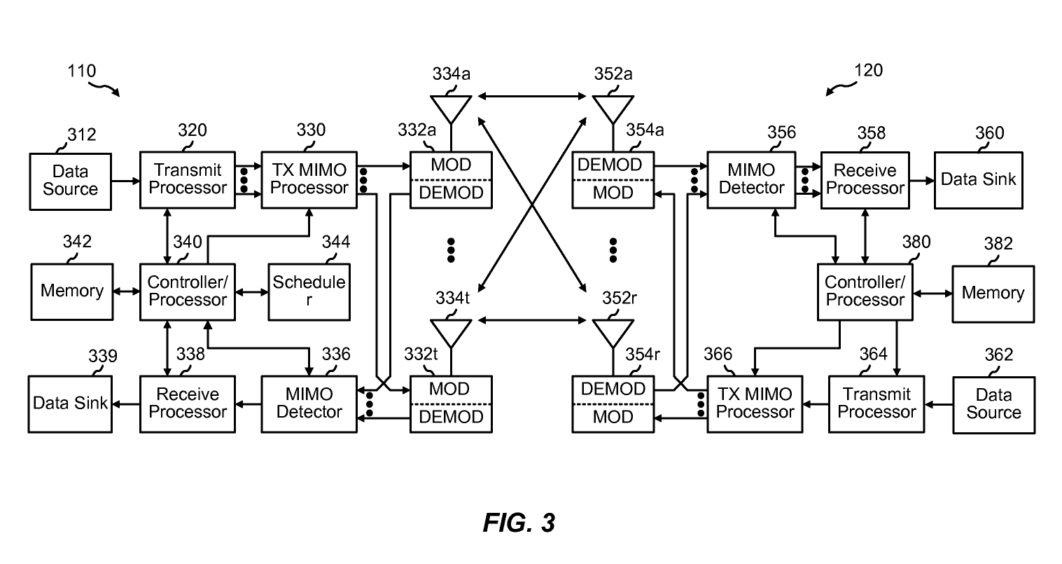

FIG. 3 shows a block diagram of a design of a base station/eNodeB 110 and a UE 120, which may be one of the base stations/eNodeBs 110 and one of the UEs 120 in FIG. 1. For a restricted association scenario, the base station 110 may be the macro eNodeB 110c in FIG. 1, and the UE 120 may be the UE 120y. The base station 110 may also be a base station of some other type. The base station 110 may be equipped with antennas 334a through 334t, and the UE 120 may be equipped with antennas 352a through 352r.

At the base station 110, a transmit processor 320 may receive data from a data source 312 and control information from a controller/processor 340. The control information may be for the PBCH, PCFICH, PHICH, PDCCH, etc. The data may be for the PDSCH, etc. The processor 320 may process (e.g., encode and symbol map) the data and control information to obtain data symbols and control symbols, respectively. The processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the base station 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The transmit processor 364 may also generate reference symbols for a reference signal. The symbols from the transmit processor 364 may be precoded by a TX MIMO processor 366 if applicable, further processed by the demodulators 354a through 354r (e.g., for SC-FDM, etc.), and transmitted to the base station 110. At the base station 110, the uplink signals from the UE 120 may be received by the antennas 334, processed by the modulators 332, detected by a MIMO detector 336 if applicable, and further processed by a receive processor 338 to obtain decoded data and control information sent by the UE 120. The receive processor 338 may provide the decoded data to a data sink 339 and the decoded control information to the controller/processor 340.

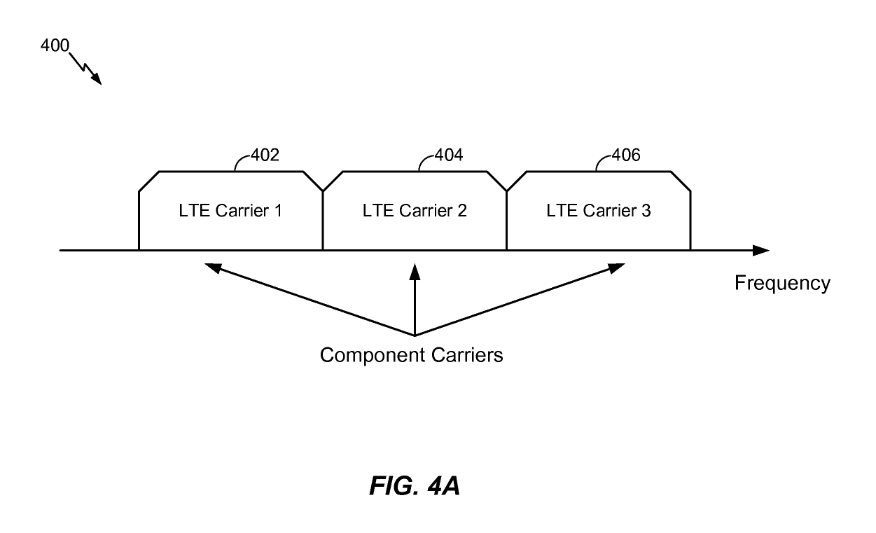

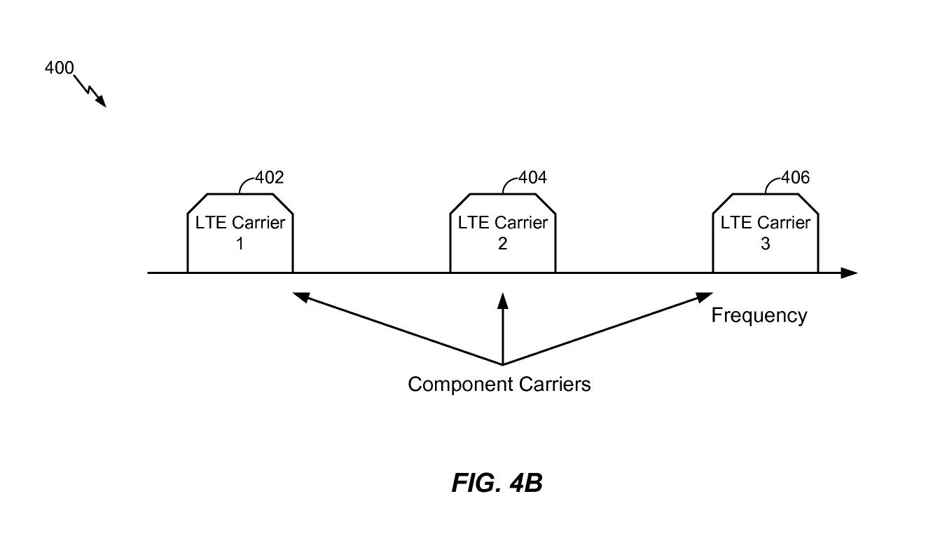

The controllers/processors 340 and 380 may direct the operation at the base station 110 and the UE 120, respectively. The processor 340 and/or other processors and modules at the base station 110 may perform or direct the execution of various processes for the techniques described herein. The processor 380 and/or other processors and modules at the UE 120 may also perform or direct the execution of the functional blocks illustrated in FIGS. 4A, 4B, 5 and 6, and/or other processes for the techniques described herein. The memories 342 and 382 may store data and program codes for the base station 110 and the UE 120, respectively. A scheduler 344 may schedule UEs for data transmission on the downlink and/or uplink.

In one configuration, the UE 120 for wireless communication includes means for detecting interference from an interfering base station during a connection mode of the UE, means for selecting a yielded resource of the interfering base station, means for obtaining an error rate of a physical downlink control channel on the yielded resource, and means, executable in response to the error rate exceeding a predetermined level, for declaring a radio link failure. In one aspect, the aforementioned means may be the processor(s), the controller/processor 380, the memory 382, the receive processor 358, the MIMO detector 356, the demodulators 354a, and the antennas 352a configured to perform the functions recited by the aforementioned means. In another aspect, the aforementioned means may be a module or any apparatus configured to perform the functions recited by the aforementioned means.

### Carrier Aggregation

In LTE-Advanced, UEs 110 use spectrum up to 20 Mhz bandwidths allocated in a carrier aggregation of up to a total of 100 Mhz (5 component carriers) used for transmission in each direction. Generally, less traffic is transmitted on the uplink than the downlink, so the uplink spectrum allocation may be smaller than the downlink allocation. For example, if 20 Mhz is assigned to the uplink, the downlink may be assigned 100 Mhz. These asymmetric FDD assignments will conserve spectrum and are a good fit for the typically asymmetric bandwidth utilization by broadband subscribers.

To meet LTE-Advanced requirements, support of transmission bandwidths wider than the 20 MHz is required. One solution is carrier aggregation. Carrier aggregation allows expansion of effective bandwidth delivered to a UE 120 through concurrent utilization of radio resources across multiple carriers. Multiple component carriers are aggregated to form a larger overall transmission bandwidth.

For the LTE-Advanced mobile systems, two types of carrier aggregation (CA) methods have been proposed, contiguous CA and non-contiguous CA. They are illustrated in FIGS. 4A and 4B. Contiguous CA 400 occurs when multiple available component carriers 402, 404, 406 are adjacent to each other (FIG. 4A). On the other hand, non-contiguous CA 400 occurs when multiple available component carriers are separated along the frequency band (FIG. 4B). Both non-contiguous and contiguous CA aggregate multiple LTE/component carriers to serve a single unit of LTE Advanced UE.

Multiple RF receiving units and multiple FFTs may be deployed with non-contiguous CA in LTE-Advanced UE since the carriers are separated along the frequency band. Because non-contiguous CA supports data transmissions over multiple separated carriers across a large frequency range, propagation path loss, Doppler shift and other radio channel characteristics may vary a lot at different frequency bands.

Thus, to support broadband data transmission under the non-contiguous CA approach, methods may be used to adaptively adjust coding, modulation and transmission power for different component carriers. For example, in an LTE-Advanced system where the eNodeB 110 has fixed transmitting power on each component carrier, the effective coverage or supportable modulation and coding of each component carrier may be different.

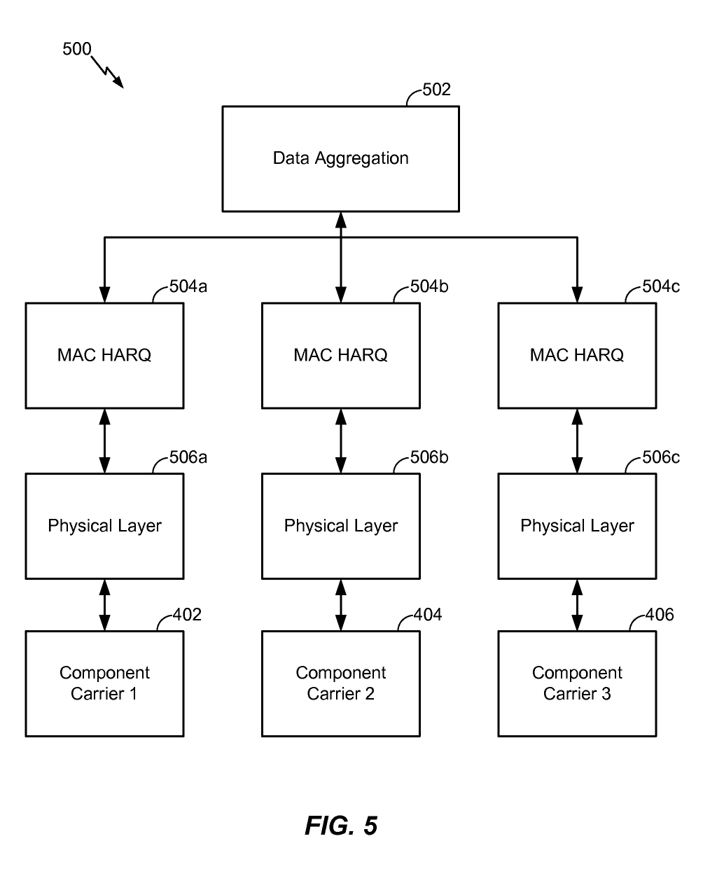

FIG. 5 illustrates aggregating transmission blocks (TBs) from different component carriers at the medium access control (MAC) layer for an IMT-Advanced system 500. With MAC layer data aggregation 502, each component carrier 402, 404, 406 has its own independent hybrid automatic repeat request (HARQ) entity 504 in the MAC layer and its own transmission configuration parameters (e.g., transmitting power, modulation and coding schemes, and multiple antenna configuration) in the physical layer 506. Similarly, in the physical layer 506, one HARQ entity is provided for each component carrier.

### Control Signaling

In general, there are three different approaches for deploying control channel signaling for multiple contiguous or non-contiguous component carriers, such as e-PDCCH signaling by an eNodeB 110 to UE 120 in an LTE-Advanced system.

The first method involves a minor modification of the control structure in LTE systems where each component carrier is given its own coded control channel.

The second method involves jointly coding the control channels of different component carriers and deploying the control channels in a dedicated component carrier. The control information for the multiple component carriers will be integrated as the signaling content in this dedicated control channel. As a result, backward compatibility with the control channel structure in LTE systems is maintained, while signaling overhead in the CA is reduced.

The third CA method involves jointly coding multiple control channels for different component carriers and then transmitting over the entire frequency band. This approach offers low signaling overhead and high decoding performance in control channels, at the expense of high power consumption at the UE side. However, this method is not compatible with LTE systems.

### Handover Control

Handover occurs when a UE 120 moves from one cell 102, covered by a first eNodeB 110, into another cell 102 covered by a second eNodeB. It is preferable to support transmission continuity during the handover procedure across multiple cells 102 when CA (FIG. 4A) is used for IMT-Advanced UE. However, reserving sufficient system resources (i.e., component carriers with good transmission quality) for the incoming UE 120 with specific CA configurations and quality of service (QoS) requirements may be challenging for the next eNodeB 110. The reason is that the channel conditions of two (or more) adjacent cells (eNodeBs) may be different for the specific UE 120. In one approach, the UE 120 measures the performance of only one component carrier in each adjacent cell 102a, 102b, 102c. This offers similar measurement delay, complexity, and energy consumption as that in LTE systems. An estimate of the performance of the other component carriers in the corresponding cell 102 may be based on the measurement result of the one component carrier. Based on this estimate, the handover decision and transmission configuration may be determined.

According to various embodiments, the UE 120 operating in a multicarrier system (also referred to as carrier aggregation) is configured to aggregate certain functions of multiple carriers, such as control and feedback functions, on the same carrier, which may be referred to as a “primary carrier.” The remaining carriers that depend on the primary carrier for support are referred to as associated secondary carriers. For example, the UE 120 may aggregate control functions such as those provided by the optional dedicated channel (DCH), the nonscheduled grants, a physical uplink control channel (PUCCH), and/or a physical downlink control channel (PDCCH). Signaling and payload may be transmitted both on the downlink by the eNode B 110 to the UE 120, and on the uplink by the UE 120 to the eNode B 110.

In some embodiments, there may be multiple primary carriers. In addition, secondary carriers may be added or removed without affecting the basic operation of the UE 120, including physical channel establishment and RLF procedures which are layer 2 procedures, such as in the 3GPP technical specification 36.331 for the LTE RRC protocol.

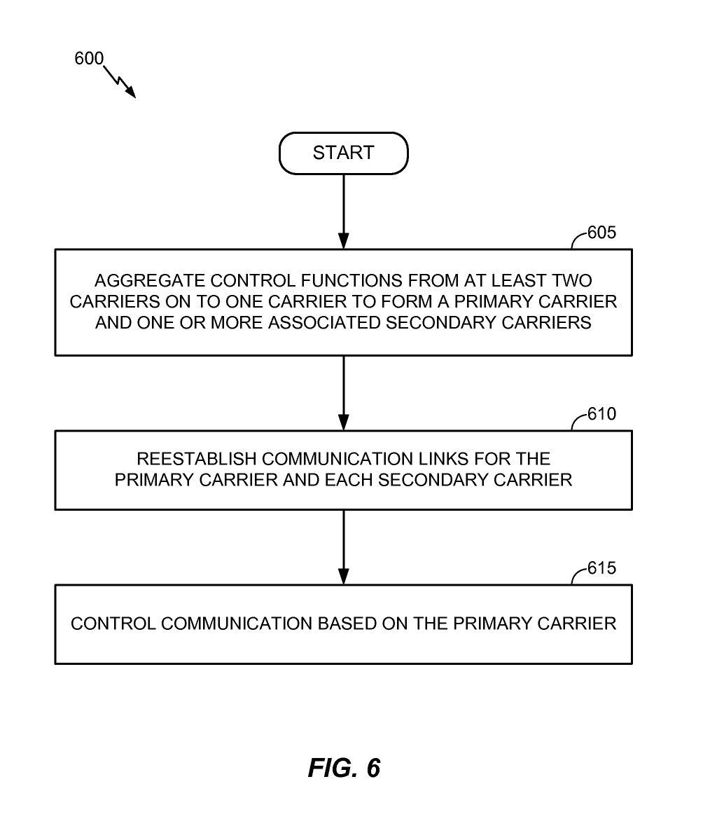

FIG. 6 illustrates a method 600 for controlling radio links in a multiple carrier wireless communication system by grouping physical channels according to one example. As shown, the method includes, at block 605, aggregating control functions from at least two carriers onto one carrier to form a primary carrier and one or more associated secondary carriers. Next at block 610, communication links are established for the primary carrier and each secondary carrier. Then, communication is controlled based on the primary carrier in block 615.

### Enhanced Physical Downlink Control Channel (e-PDCCH)

Certain embodiments of the present disclosure provide methods and apparatuses for enhanced physical downlink control channel (e-PDCCH) signaling. Many motivations exist for utilizing some type of e-PDCCH that provides benefits over existing (or legacy) physical downlink control channels. For example, e-PDCCH may improve carrier aggregation (CA) enhancements. e-PDCCH may help support new carriers, which may not be backwards compatible with legacy designs, and may reduce control channel capacity limitations of coordinated multipoint (CoMP) transmissions, and enhance DL MIMO.

According to aspects of the present disclosure, an e-PDCCH may support increased control channel capacity and frequency-domain Inter Cell Interference Coordination (ICIC). e-PDCCH may achieve improved spatial reuse of control channel resources. As well, the e-PDCCH may support beamforming and/or diversity, operate on new carrier types and in Multicast-Broadcast Single Frequency Network (MBSFN) sub-frames, and may coexist on the same carrier as legacy UEs. The e-PDCCH may be scheduled in a frequency-selective manner and may mitigate inter-cell interference.

### Example Transmission Structure for e-PDCCH

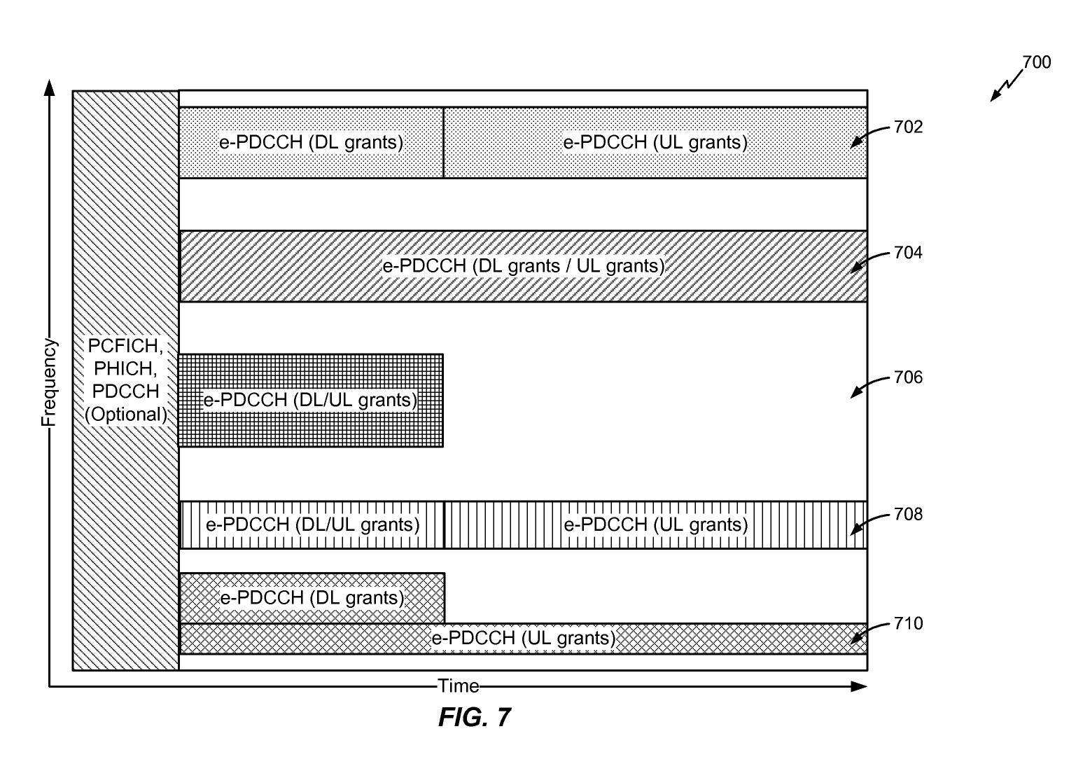

FIG. 7 illustrates possible transmission structures for e-PDCCH 700, according to aspects of the present disclosure. As will be described in greater detail below, aspects presented herein provide various schemes for e-PDCCH placement, including: placement similar to that used with a relay PDCCH (R-PDCCH), a pure-FDM scheme, a TDM scheme, and a hybrid scheme that utilizes both TDM and FDM.

According to a first alternative 702, an e-PDCCH may be transmitted similarly to transmission of the R-PDCCH. In this case, DL grants may be transmitted in a first slot and UL grants may be transmitted in a second slot. According to aspects, the second slot may be used for downlink data transmission if it is not being used for transmission of grants.

According to a second alternative 704, the e-PDCCH may be transmitted in a pure FDM scheme, wherein DL grants and UL grants span the resource block. As shown, a set of resources in the frequency domain are allocated for transmission of e-PDCCH across a time domain comprising a first time slot and a second time slot. According to certain aspects, a subset of RBs multiplexed in the frequency domain with PDSCH are allocated for transmitting e-PDCCH including both uplink and downlink grants across the first and second time slots.

According to a third alternative 706, the e-PDCCH may be transmitted in a first slot according to a TDM scheme, wherein DL and UL grants are transmitted in a first slot. As illustrated, the remaining RBs may be utilized for transmitting the PDSCH data transmissions.

According to a fourth alternative 708, the e-PDCCH may be transmitted in a manner similar to R-PDCCH, wherein DL and UL grants may be transmitted in a first slot and UL grants may be transmitted in a second slot. According to certain aspects, if a DL grant is transmitted in a first physical resource block (PRB) of a given PRB pair, then an UL grant may be transmitted in a second PRB of the PRB pair. Otherwise, an UL grant may be transmitted in either the first or second PRB of the PRB pair.

According to a fifth alternative, 710, the e-PDCCH may be transmitted using TDM for DL grants in a first slot and FDM for UL grants spanning a first and second slot.

### Physical channel characteristics for e-PDCCH in LTE

Certain aspects of the present disclosure provide various options and details regarding physical channel characteristics for transmitting e-PDCCH by a base station and processing e-PDCCH by a user equipment (UE). These physical channel characteristics may include, for example, a transmission rank for an e-PDCCH transmission, one or more antenna ports used for the e-PDCCH transmission, and a rate matching scheme for the e-PDCCH (e.g., wherein rate matching is performed around at least one of CSI-RS or CRS).

Regarding transmission rank, in some cases, a higher rank (for example, greater than 1) may be desired for e-PDCCH as compared with MU-MIMO. Transmission rank generally refers to the number of distinct transmitted layers (e.g., the number of eigenvectors on which transmissions occur).

According to certain aspects of the present disclosure, a rank of a UE 120 during e-PDCCH transmission may be determined in a variety of different manners. For example, according to a first method, a UE may determine rank based on blind decodes (e.g., to detect between rank 1 and rank 2).

According to a second method, a rank may be assigned based on a configuration of a Radio Resource Control (RRC) protocol between the UE 120 and a corresponding eNodeB 110. This method may also include a fallback operation, wherein legacy PDCCH is enabled upon re-configuration. A fallback operation may be performed when the eNodeB faces some period of ambiguity between the new and the old configuration.

According to a third method, the rank may be assigned based on a format size of a downlink control information (DCI) of a PDCCH. This method may associate higher ranks with larger DCI format sizes and associate lower ranks with smaller DCI format sizes. For example, DCI format 1A/0 may always assume rank 1 operation and Mode-dependent DL DCI formats and UL MIMO DCI format 4 may be configured with rank 1 or higher operations.

According to a fourth method, the rank determination may be “UE-assisted.” For instance, the UE 120 reports the desired rank for the ePDCCH transmission. The eNodeB 110 then follows the UE's recommendations. As an example, the UE 120 follows the last report RI in CSI reporting. In case of two restricted measurement subsets and two configured P-CSI reporting sets (for example, one clean, and the other unclean), additional configuration may be required to determine which of the two configured P-CSI reporting sets to follow. In an example, a clean one may be used as the baseline.

According to some other example embodiments, a current e-PDCCH may include some info bit(s) to indicate rank of future e-PDCCH(s). The future rank information may be decoded.

According to certain aspects, e-PDCCH rank may be subframe-dependent. In other words, different ranks may be associated with e-PDCCH decoding candidates in different subframes. For example, a first rank is associated with a first decoding candidate for the e-PDCCH in a first subframe, while a second rank is associated with a second decoding candidate for the e-PDCCH in a second subframe.

In some cases, different ranks may be associated with different candidates with the same subframe. For example, a first rank (e.g., rank 1) may be used for a first decoding candidate in a subframe and a second rank (e.g., rank 2) may be used for a second decoding candidate in the same subframe. As another example, a first rank (e.g., rank 1) may be used for a decoding candidate in a common search space, while a second rank (e.g., rank 2) is used for a decoding candidate in a UE-specific search space.

According to certain aspects, a UE may be configured with two or more sets of resources for an e-PDCCH and wherein the rank may depend on the set of resources associated with the e-PDCCH. For example, a first rank (e.g., rank 1) may be used with a first set of resources, while a second rank (e.g., rank 2) may be used for a second set of resources.

According to certain aspects, e-PDCCH rank may depend on the number of UEs targeted by a transmission. For example, a first rank (e.g., rank 2) may be associated with the e-PDCCH for a unicast transmission, while a second rank (e.g., rank 1) is associated with the e-PDCCH for a broadcast or multicast transmission.

According to certain aspects, e-PDCCH rank may depend on whether the e-PDCCH transmission uses localized or distributed resources. For example, a first rank (e.g., rank 1) may be associated with the e-PDCCH of a distributed transmission, while a second rank (e.g., rank 2) may be associated with the e-PDCCH of a localized transmission.

### Antenna Ports

According to example embodiments, a choice of antenna ports associated with a channel between the UE 120 and eNodeB 110 may depend on whether a higher rank (for example, greater than rank 1)/MU-MIMO is supported for e-PDCCH, and whether e-PDCCH and PDSCH are spatially multiplexed. Generally, antenna port(s) for e-PDCCH can be determined using any one of the following methods.

According to a first example method, the antenna port assignment is fixed based on the determined rank for e-PDCCH. For example, port 7 for rank 1 and ports 7 & 8 for rank 2.

According to a second example method, the antenna port assignment is RRC configured (for example, one or more of the ports 7-10. This example assignment may also include separately configuring antenna ports or associated the assignment with other configurations, for example, CSI reference symbol (CSI-RS) configuration, mapping from the lowest CSI-RS port(s) to e-PDCCH port(s).

According to a third example method, the antenna assignment is dynamically used for e-PDCCH. In the case the UE 120 may blindly detect which port to use based on, for example, a fixed number of ports (for instance, ports 7 and 8) or layer 3 configured a set of ports. For instance, UE1 may utilize ports 7 and 8 and UE2 may utilize ports 9 and 10. In this case, a max number of blind decodes increases under the same number of decoding candidates. It may, therefore, be desired to restrict the number of decoding candidates to maintain max number of blind decodes.

According to a fourth example method, the antenna assignment may be transmitted sub-frame-dependent and/or may also be UE dependent. This method may be desired to effectively enable MU-MIMO without increasing a number of blind decodes. For example, during sub-frame #0, a portion of the UE's 120 may use any one of antenna ports 0, 7 or 8. During sub-frame #1, this portion of UE's may use an antenna port different from the antenna ports used during sub-frame #0. As is seen, the antenna ports used by the UE's are distributed during each sub-frame. In some instances, even sub-frames (or configured sub-frame indices) may use port 7, and odd sub-frames may use port 8. The antenna port assignment in this example may also depend on an ID of the UE, for example, port=f(sub-frame index, UE ID).

### Channel State Information (CSI) Feedback for e-PDCCH

Generally, feedback is targeted to data transmission and there is no dedicated CSI feedback from the UE side for e-PDCCH. CSI feedback is provided on the existing channel that provides feedback for data transmission. The eNodeB 110 implementation generally controls how to utilize existing CSI-feedback for PDSCH for the purpose of e-PDCCH management. CSI feedback can be performed independent of the rank of the UE 120 and/or the antenna port utilized during transmission. In other embodiments, the CSI feedback may depend on the rank of the UE 120 and/or the antenna port utilized during transmission. In the case of two subsets of CSI reports, one of the two may be chosen (for example, clean CSI reporting) for e-PDCCH.

However, for more efficient e-PDCCH operation, it may be desired to have CSI feedback dedicated for e-PDCCH where the CSI feedback regarding the e-PDCCH is sent on a channel separate from the data transmission feedback on the downlink communication channel. There may be certain advantages (or distinct properties) of having a CSI feedback for e-PDCCH. For example, fast tracking of channel for e-PDCCH may not be required. Stated otherwise, there may be no need to track channel variations very closely. It is sufficient to track the channel trend. The fast tracking may not be required due to lack of H-ARQ and the beamforming/power control for e-PDCCH is expected to be more conservative than those for PDSCH. Also, a longer term CQI/PMI/RI filtering is desirable.

Another advantage may be that a Set S (set of frequency resources) may be used for CSI feedback. The resources used to provide feedback do not need to include entire bandwidth, unlike channel feedback for data transmissions that are defined for entire bandwidth. Currently, the Set S for CSI feedback for PDSCH is fixed at the entire downlink system bandwidth. For CSI feedback for e-PDCCH, the Set S can be the same as the set of resources configured for e-PDCCH. As mentioned, it may not necessarily to include the entire downlink system bandwidth. CSI feedback for e-PDCCH may not be the same as that for PDSCH.

According to certain embodiments, various designs for CSI feedback for e-PDCCH are possible. According to a first example design for CSI feedback for e-PDCCH, a channel separate from the PDSCH is configured to provide CSI feedback for e-PDCCH. For example, this may include separate configurations (similar to CA case).

According to a second example design for CSI feedback for e-PDCCH, the existing CSI feedback for e-PDCCH (one configuration, no reporting structure change) may be utilized. The existing CSI feedback channel may be revised to include additional information for e-PDCCH management. This additional information may include, for example, codebook subset restriction which can be used to limit the reported rank, yet include some flexible rank reports for the data channel. Presently, in certain instances, the same codebook subset restriction applies to both types of reports. Having some separate makes it possible to have one report (e.g., periodic) more biased towards e-PDCCH and the other one more towards PDSCH.

According to a third example design for CSI feedback for e-PDCCH, a current reporting structure (one configuration) may be revised to include, for example, some form of wideband-delta CQI and/or double RI. For example, CQI feedback may assume a specific precoding or a cycle of some random precoding patterns (e.g., open loop beamforming). In an example Double RI, the UE 120 may report two ranks, one for PDSCH and the other for e-PDCCH. The reported RI value for e-PDCCH can be filtered over a longer term, and can be subject to a different set of limitations (e.g., e-PDCCH rank 1 or rank 2, while PDSCH can be up to rank 8). The reporting periodicity of RI for e-PDCCH can be longer than that for PDSCH.

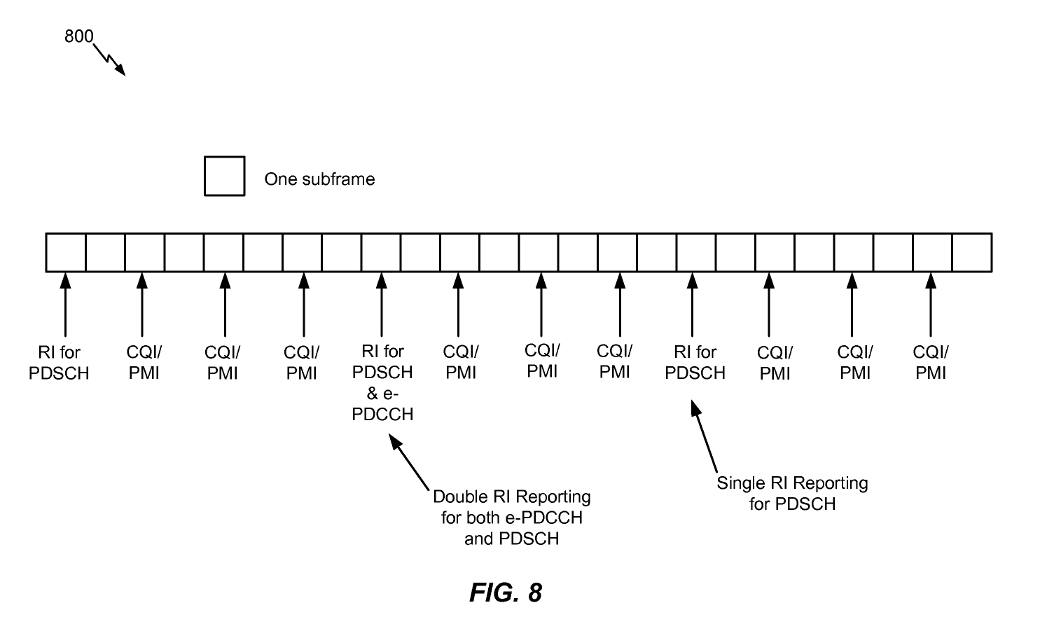

In another example, a periodic CSI may allow more changes than those offered by periodic CSI. FIG. 8 illustrates an example double RI reporting structure 800 for CSI feedback, according to certain aspects of the present disclosure. As is seen, the Double RI Reporting for both e-PDCCH and PDSCH may be piggybacked in the structure. CQI/PMI may contain reports for PDSCH only, or may be revised to contain reports for e-PDCCH (delta reporting), if possible.

The CSI feedback may further be dependent on the RS type defined for e-PDCCH. For cell reference signal (CRS) based e-PDCCH, transmit diversity based; for UE-RS based, either open loop or closed loop beamforming.

### Coding and Modulation

According to example embodiments, control information for PDCCH may be sent by controller/processor 340 to transmit processor 320. The processor 320 may process control information to obtain control symbols and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. In some example embodiments, MODs 332 may use some form of convolution coding. For example, turbo coding may be used.

According to example embodiments, it may also be possible to use modulation schemes, for example, higher order modulation schemes. In such instances, it may be desirable to inform the UE 120 of the order of modulation by way of, for example, RRC configuration or via blind decoding. The modulation may be dependent on the level of transmission. The modulation may also depend on the e-PDCCH structure.

According to some example embodiments, higher modulation may depend on the resource granularity. For instance, higher order modulation may be supported if the minimum resource unit for e-PDCCH is beyond a threshold (e.g., 100 resource elements). According to example embodiments, higher modulation such as 16QAM can be considered. The higher order modulation may be enabled for low aggregation level(s). The higher order modulation may be part of blind decodes (UE blindly decodes QPSK vs. 16QAM), or radio resource control (RRC) configuration (whether QPSK or 16QAM).

In an example, for Level 1, QPSK or 16-QAM may be used, while for Level 2, 4 or 8, QPSK may be used. According to certain embodiments, Traffic to Pilot Ratio (TPR) (power of PDCCH with respect to that of the reference signals) may be considered when using higher order modulation. The TPR management may depend on the e-PDCCH structure. In some scenarios, TPR may be assumed to be zero (0). For FDM based e-PDCCH, TPR for e-PDCCH can be flexible, although for higher order mod, TPR is a concern. For TDM based e-PDCCH, the TPR for e-PDCCH can be either the same as PDSCH or with some flexibility.

If a higher order modulation, for example, 16QAM is used, the e-PDCCH power versus reference signal to decode e-PDCCH may become more sensitive compared with the case of QPSK for e-PDCCH. Generally, while designing TPR for 16QAM or any other modulation scheme, the UE assumes a fixed TPR value (e.g., about 0 dB). This can be similar to the handling of TPR for PDSCH.

In an alternative, UE can be configured with a finite set of TPR values (e.g., two sets, one high and one low). UE then performs TPR estimation based on a predefined/known signaling set (for example, a binary control signal) to determine which one is in use for e-PDCCH.

According to certain aspects, the modulation scheme may depend on an aggregation level associated with the e-PDCCH.

According to certain aspects, different modulation schemes may be used for different decoding candidates in different subframes. For example, a first modulation scheme may be associated with a first decoding candidate for the e-PDCCH in a first subframe, while a second modulation scheme is associated with a second decoding candidate for the e-PDCCH in a second subframe.

According to certain aspects, different modulation schemes may be associated with different decoding candidates within the same subframe. For example, QPSK may be used for a first decoding candidate in a subframe, while 16QAM is used for a second decoding candidate in the same subframe. As another example, QPSK may be used for a decoding candidate in a common search space, while 16QAM is used for a decoding candidate in a UE-specific search space.

According to certain aspects, different modulation schemes may be used if different sets of resources are used for e-PDCCH. For example, a first modulation scheme (e.g., QPSK) may be used for a first set of resources, while a second modulation scheme (e.g., 16QAM) may be used for a second set of resources.

According to certain aspects, different modulation schemes may be used for different types of e-PDCCH transmissions. For example, a first modulation scheme (e.g., 16QAM) may be associated with the e-PDCCH for a unicast transmission, while a second modulation scheme (e.g., QPSK) may be associated with e-PDCCH for a broadcast or multicast transmission.

According to certain aspects, different modulation schemes may be used depending on whether e-PDCCH is transmitted using localized or distributed resources. For example, a first modulation scheme (e.g., QPSK) may be associated with the e-PDCCH of a distributed transmission, while a second modulation scheme (e.g., 16QAM) may be associated with the e-PDCCH of a localized transmission.

### Resource Element Mapping

RE mapping may be done similarly to R-PDCCH. Specifically, frequency first, time second for non-interleaving based e-PDCCH. If REG-based e-PDCCH is supported, time first, frequency second. R-PDCCH is typically rate matched around CRS of the serving cell, and CSI-RS of the serving and neighboring cells. e-PDCCH should also at least rate match around CRS of the serving cell, and CSI-RS of the serving and neighboring cells. This can also be performed based on rate match around CRS of neighboring cells.

In some cases, UE-RS may be required to be supported for e-PDCCH. For distributed (frequency diversity) e-PDCCH, transmit diversity defined for legacy PDCCH (based on CRS) or cycling of beams (based on DM-RS) may be used. A comparable performance is seen. CRS based solution has less overhead, if e-PDCCH is not multiplexed with DM-RS based PDSCH in the same PRB pair (DM-RS overhead is at least 6 REs/RB/slot).

DM-RS based solutions may be applicable to a wider variety of scenarios. For a new carrier type, there may be no CRS or reduced CRS. For a TDM based approach, CRS based solutions may offer more efficient solution to multiplex with CRS based PDSCH in the same PRB pair. Unless DM-RS is only present in the first slot (which is possible) for e-PDCCH demodulation, a CRS based solution may be necessary.

A variety of different reference symbol types may be used for e-PDCCH transmit diversity. These types may include CRS, localized CRS in case of MBSFN sub-frames or extension carriers, DM-RS, and may utilize a current pattern (no strong need to change the pattern for e-PDCCH). In some cases, RS may be limited to 6 REs per RB. In this cases, DM-RS may be preferable due to its versatility. Although in regular sub-frames when CRS is present, RS overhead may be large (can be beneficial for high speed scenarios).

A transmit diversity scheme may include space frequency block codes (SFBC), based on the REG concept as defined for legacy PDCCH and/or Beam cycling. A minimum unit for beam switching may be a resource element group (REG) or some other units. For beam switching based diversity schemes, within a PRB pair, an e-PDCCH may consist of one or more REGs. The set of REGs in the PRB pair may be respectively used by one or more ePDCCHs.

One or more antenna ports may be associated with the REGs in the PRB pair. As an example, antenna ports 7 and 9 may be associated with the set of REGs in the PRB pair. In order to ensure good e-PDCCH performance, the association of REGs to the antenna ports can be done on a per ePDCCH (or per UE) basis. As an example, a PRB pair may consist of 8 REGs, namely, {REG0, REG1, . . . REG7}. A first e-PDCCH may be associated with {REG0, REG1, REG7}, a second e-PDCCH may be associated with {REG2, REG5, REG6}, and a third e-PDCCH may be associated with {REG3, REG4}. Antenna ports 7 and 9 may be associated with the set of REGs for the PRB pair. With UE-specific or e-PDCCH specific REG to antenna port association, {REG0, REG1, REG7} for the first e-PDCCH may be associated with antenna ports {7, 9, 7}, respectively, {REG2, REG5, REG6} for the second e-PDCCH may be associated with antenna ports {7, 9, 7}, respectively, and {REG3, REG4} for the third e-PDCCH may be associated with antenna ports {7, 9}, respectively. This may be in contrast with a cell-specific association, where {REG0, REG1, REG7} may be associated with antenna ports {7, 9, . . . , 9}, respectively. Additionally, the starting antenna port can further be differently derived for different e-PDCCHs. As an example, {REG2, REG5, REG6} for the second e-PDCCH discussed earlier may alternatively be associated with {9, 7, 9}, respectively.

For beam switching based diversity scheme, antenna port association may have a different granularity from eREG as discussed earlier. As an example, the granularity can be on a per RE basis. Similar to the eREG based granularity, for RE based granularity, cell specific alternate association or downlink control information (DCI) specific antenna association may be applied. In addition, the alternate association may or may not exclude the REs occupied by other signals (e.g., CRS, CSI-RS, etc.).

One example may assume there are 16 eREGs, with 9 REs for each eREGs, in a PRB pair. In this case, Antenna port 7 and antenna port 8 can be alternately associated with every 16 REs, where the REs are ordered in a frequency-first, time-second manner, i.e., REs 0-15, 32-47, 64-79, 96-111, and 128-143 are associated with antenna port 7, while REs 16-31, 48-63, 80-95, and 112-127 are associated with antenna port 8. In this example, some REs may be occupied by other signals thus not available for ePDCCH transmission. As a result, the number of available REs associated with one antenna port may be much larger than the number of available REs associated with the other antenna port. Such imbalance may negatively impact performance of the distributed EPDCCH transmission.

Alternatively, the association for the REs mapped to a given DCI can be specified based on the actual eREGs associated with the DCI. Instead of specifying antenna port association regardless of whether a RE is occupied by other signals or not, alternating antenna port association can be performed by excluding the REs occupied by other signals in order to better balance the association for the two antenna ports. Note that such association may be performed on a per eREG basis (of the REGs associated with the DCI), or on a per PRB basis (of the PRB pairs associated with the DCI), or on a per DCI basis.

In particular, the association can alternate over all the available REs associated with the DCI. This would ensure a good balance between the two antenna ports is achieved. As an example, suppose a DCI is transmitted with two eCCEs, consisting of 8 REGs, each of 9 REs. However, among the 72 REs occupied by the 8 REGs, assuming that only 50 REs are indeed available for the DCI, after discounting the REs occupied by other signals, the association can be specified such that REs 0, 2, 4, . . . , and 48 are associated with antenna port 7, while REs 1, 3, 5, . . . , and 49 associated with antenna port 8.

Alternatively, beam switching may be realized by using a single antenna port, but by applying a set of fixed precoding across different REGs. As an example, two precoding vectors may be defined as [+1, +1] and [+1, −1], indexed by precoder 0 and precoder 1. If an ePDCCH is associated with {REG0, REG1, REG7} in a PRB pair, the three REGs can be associated with the same antenna port 7, but may be further associated with precoder {0, 1, 0}, respectively.

In other words, a set of N precoders can be defined and a different precoder is used every N REGs. REGs in different PRB pairs of the same ePDCCH may determine the corresponding precoders jointly or separately. As an example, if an ePDCCH is associated with {REG0, REG1, REG7} of a first PRB pair, and {REG5, REG6} of a second PRB pair, the precoding vector can be jointly determined for the two PRB pairs as {0, 1, 0}, and {1, 0}, respectively. Alternatively, the precoding vector can be separately determined for the two PRB pairs as {0, 1, 0}, and {0, 1}, respectively.

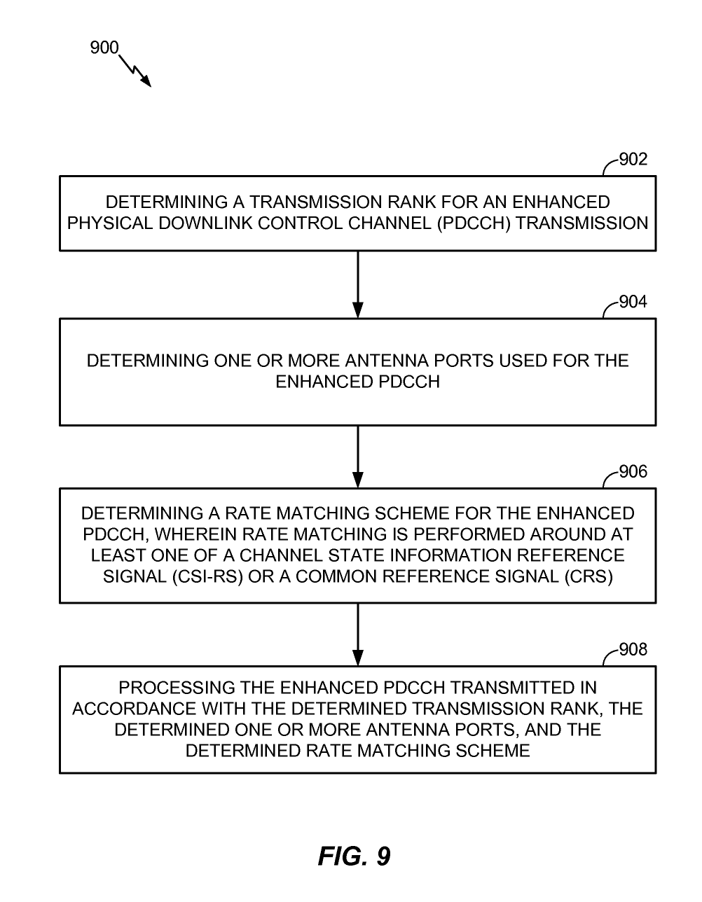

FIG. 9 illustrates example operations 900 for wireless communications by a UE according to certain aspects of the present disclosure. Operations illustrated by the example method 900 may be performed, for example, at the processor 380 of the UE 120 of FIG. 3.

The operation may begin, at block 902, by determining a transmission rank for an enhanced physical downlink control channel (PDCCH) transmission. At 904, the UE may determine one or more antenna ports used for the enhanced PDCCH. At 906, the UE may determine a rate matching scheme for the enhanced PDCCH, wherein rate matching is performed around at least one of a channel state information reference signal (CSI-RS) or a common reference signal (CRS). At 908, the UE may process the enhanced PDCCH transmitted in accordance with the determined transmission rank, the determined one or more antenna ports, and the determined rate matching scheme.

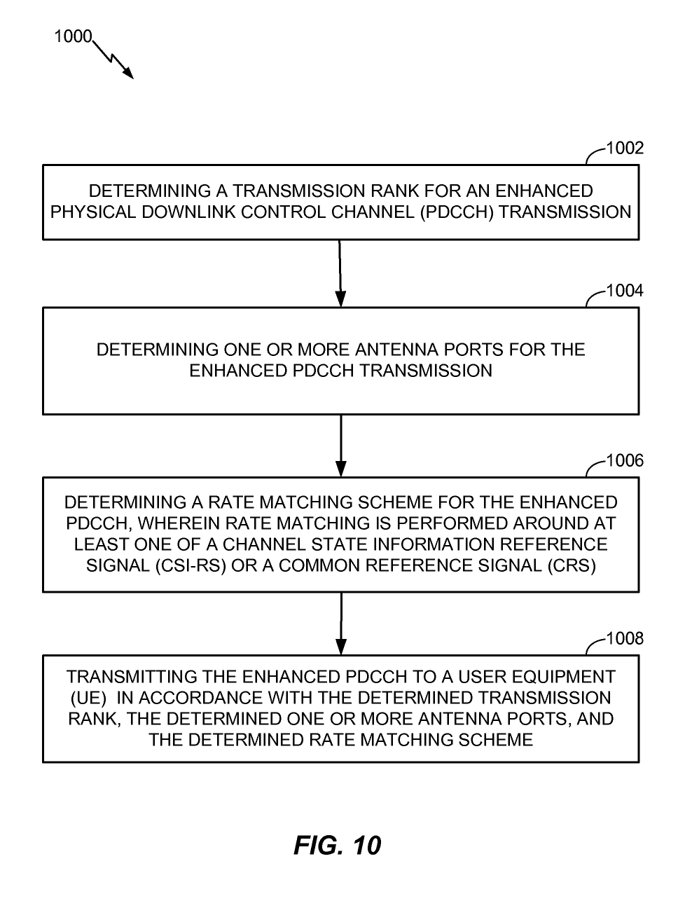

FIG. 10 illustrates example operations 1000 for wireless communications by a base station according to certain aspects of the present disclosure. Operations illustrated by the example method 1000 may be performed, for example, at the processor 340 of the access terminal 110 of FIG. 3.

The operation may begin, at block 1002, by determining a transmission rank for an enhanced physical downlink control channel (PDCCH) transmission. At 1004, the base station determines one or more antenna ports used for the enhanced PDCCH transmission. At 1006, the base station determines a rate matching scheme for the enhanced PDCCH, wherein rate matching is performed around at least one of a channel state information reference signal (CSI-RS) or a common reference signal (CRS). At 1008, the base station transmits the enhanced PDCCH to a user equipment (UE) in accordance with the determined transmission rank, the determined one or more antenna ports, and the determined rate matching scheme.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communications by a user equipment (UE), comprising:
determining a transmission rank for an enhanced physical downlink control channel (PDCCH) transmission;
determining one or more antenna ports used for the enhanced PDCCH;
determining a rate matching scheme for the enhanced PDCCH, wherein rate matching is performed around at least one of a channel state information reference signal (CSI-RS) or a common reference signal (CRS); and
processing the enhanced PDCCH transmitted in accordance with the determined transmission rank, the determined one or more antenna ports, and the determined rate matching scheme.

2. The method of claim 1, wherein the one or more antenna ports are determined based, at least in part, on the determined transmission rank.

3. The method of claim 1, wherein the one or more antenna ports are determined based, at least in part, as a function of an identification of the UE.

4. The method of claim 1, wherein the one or more antenna ports are determined based on at least one of: a downlink control information (DCI) format or a received radio resource control signaling.

5. The method of claim 1, wherein the enhanced PDCCH is transmitted using a transmit diversity scheme utilizing at least one of: space frequency block codes (SFBC) based on a resource element group (REG) concept or beam cycling.

6. The method of claim 1, comprising determining at least two antenna ports associated with a set of resource elements (REs) associated with a downlink control information, wherein an association of the REs with the at least two antenna ports for an enhanced PDCCH is determined specific to the resource elements associated with the enhanced PDCCH.

7. The method of claim 6, wherein the association is in an alternate manner and further comprising excluding the REs occupied by other signals.

8. The method of claim 1, wherein the rate matching comprises:
performing rate matching around common reference signals (CRS) of a serving cell.

9. The method of claim 1, wherein the rate matching comprises:
performing rate matching around CSI-RS configured for the UE.

10. The method of claim 1, wherein the rate matching comprises:
performing rate matching around common reference signals (CRS) of one or more neighboring cells.

11. The method of claim 1, further comprising:
determining a modulation scheme for the enhanced PDCCH, where the modulation scheme comprises at least QPSK.

12. The method of claim 11, wherein the modulation scheme further depends on an aggregation level associated with the enhanced PDCCH.

13. The method of claim 11, wherein:
a first modulation scheme is associated with a first decoding candidate for the enhanced PDCCH in a first subframe; and
a second modulation scheme is associated with a second decoding candidate for the enhanced PDCCH in a second subframe.

14. The method of claim 13, wherein the first subframe and the second subframe are the same.

15. The method of claim 11, further comprising configuring two or more sets of resources for the enhanced PDCCH, and wherein the modulation scheme further depends on the set of resources associated with the enhanced PDCCH.

16. The method of claim 11, wherein:
a first modulation scheme is associated with the enhanced PDCCH for a unicast transmission; and
a second modulation scheme is associated with the enhanced PDCCH for a broadcast or multicast transmission.

17. The method of claim 11, wherein:
a first modulation scheme is associated with the enhanced PDCCH of a distributed transmission; and
a second modulation scheme is associated with the enhanced PDCCH of a localized transmission.

18. The method of claim 11, further comprising:
determining a Traffic to Pilot Ratio (TPR) for a modulation scheme with a modulation order higher than 2.

19. The method of claim 18, wherein the TPR is assumed to be 0 dB.

20. The method of claim 18, wherein the TPR is determined based on a limited set of possible values configured for a user equipment (UE).

21. The method of claim 1, further comprising:
determining a downlink control information (DCI) format; and
determining the transmission rank for the enhanced physical downlink control channel (PDCCH) transmission, based on the DCI format.

22. The method of claim 21, wherein higher ranks are associated with larger DCI format sizes and lower ranks are associated with smaller DCI format sizes.

23. The method of claim 21, further comprising decoding future rank information in a current enhanced PDCCH.

24. The method of claim 1, wherein:
a first rank is associated with a first decoding candidate for the enhanced PDCCH in a first subframe; and
a second rank is associated with a second decoding candidate for the enhanced PDCCH in a second subframe.

25. The method of claim 24, wherein the first subframe and the second subframe are the same.

26. The method of claim 24, further comprising configuring two or more sets of resources for the enhanced PDCCH, and wherein the rank further depends on the set of resources associated with the enhanced PDCCH.

27. The method of claim 24, wherein:
a first rank is associated with the enhanced PDCCH for a unicast transmission; and
a second rank is associated with the enhanced PDCCH for a broadcast or multicast transmission.

28. The method of claim 24, wherein:
a first rank is associated with the enhanced PDCCH of a distributed transmission; and
a second rank is associated with the enhanced PDCCH of a localized transmission.

29. The method of claim 1, further comprising:
providing channel state information (CSI) feedback regarding the enhanced PDCCH separate from a feedback provided for data transmission on a downlink communication channel.

30. The method of claim 29, wherein providing the CSI feedback comprises providing the CSI feedback on an existing channel that provides a feedback for data transmission.

31. A method for wireless communications by a base station, comprising:
determining a transmission rank for an enhanced physical downlink control channel (PDCCH) transmission;
determining one or more antenna ports used for the enhanced PDCCH transmission;
determining a rate matching scheme for the enhanced PDCCH, wherein rate matching is performed around at least one of a channel state information reference signal (CSI-RS) or a common reference signal (CRS); and
transmitting the enhanced PDCCH to a user equipment (UE) in accordance with the determined transmission rank, the determined one or more antenna ports, and the determined rate matching scheme.

32. The method of claim 31, wherein the one or more antenna ports are determined based, at least in part, on the determined transmission rank.

33. The method of claim 31, wherein the one or more antenna ports are determined based, at least in part, as a function of an identification of the UE.

34. The method of claim 31, wherein the one or more antenna ports are determined based on at least one of: a downlink control information (DCI) format or a received radio resource control signaling.

35. The method of claim 31, wherein the enhanced PDCCH is transmitted using a transmit diversity scheme utilizing at least one of: space frequency block codes (SFBC) based on a resource element group (REG) concept or beam cycling.

36. The method of claim 31, comprising determining at least two antenna ports associated with a set of resource elements (REs) associated with a downlink control information, wherein an association of the REs with the at least two antenna ports for an enhanced PDCCH is determined specific to the resource elements associated with the enhanced PDCCH.

37. The method of claim 36, wherein the association is in an alternate manner and further comprising excluding the REs occupied by other signals.

38. The method of claim 31, wherein the rate matching comprises:
performing rate matching around common reference signals (CRS) of a serving cell.

39. The method of claim 31, wherein the rate matching comprises:
performing rate matching around CSI-RS configured for the UE.

40. The method of claim 31, wherein the rate matching comprises:
performing rate matching around CRS of one or more neighboring cells.

41. The method of claim 31, further comprising:
determining a modulation scheme for the enhanced PDCCH, where the modulation scheme comprises at least QPSK.

42. The method of claim 41, wherein the modulation scheme further depends on an aggregation level associated with the enhanced PDCCH.

43. The method of claim 41, wherein:
a first modulation scheme is associated with a first decoding candidate for the enhanced PDCCH in a first subframe; and
a second modulation scheme is associated with a second decoding candidate for the enhanced PDCCH in a second subframe.

44. The method of claim 43, wherein the first subframe and the second subframe are the same.

45. The method of claim 41, further comprising configuring two or more sets of resources for the enhanced PDCCH, and wherein the modulation scheme further depends on the set of resources associated with the enhanced PDCCH.

46. The method of claim 41, wherein:
a first modulation scheme is associated with the enhanced PDCCH for a unicast transmission; and
a second modulation scheme is associated with the enhanced PDCCH for a broadcast or multicast transmission.

47. The method of claim 41, wherein:
a first modulation scheme is associated with the enhanced PDCCH of a distributed transmission; and
a second modulation scheme is associated with the enhanced PDCCH of a localized transmission.

48. The method of claim 41, further comprising:
determining a Traffic to Pilot Ratio (TPR) for a modulation scheme with a modulation order higher than 2.

49. The method of claim 48, wherein the TPR is assumed to be 0 dB.

50. The method of claim 48, wherein the TPR is determined based on a limited set of possible values configured for a user equipment (UE).

51. The method of claim 31, further comprising:
determining a downlink control information (DCI) format; and
determining the transmission rank for the enhanced physical downlink control channel (PDCCH) transmission, based on the DCI format.

52. The method of claim 51, wherein higher ranks are associated with larger DCI format sizes and lower ranks are associated with smaller DCI format sizes.

53. The method of claim 51, further comprising transmitting future rank information in a current enhanced PDCCH.

54. The method of claim 31, wherein:
a first rank is associated with a first decoding candidate for the enhanced PDCCH in a first subframe; and
a second rank is associated with a second decoding candidate for the enhanced PDCCH in a second subframe.

55. The method of claim 54, wherein the first subframe and the second subframe are the same.

56. The method of claim 54, further comprising configuring two or more sets of resources for the enhanced PDCCH, and wherein the rank further depends on the set of resources associated with the enhanced PDCCH.

57. The method of claim 54, wherein:
a first rank is associated with the enhanced PDCCH for a unicast transmission; and
a second rank is associated with the enhanced PDCCH for a broadcast or multicast transmission.

58. The method of claim 54, wherein:
a first rank is associated with the enhanced PDCCH of a distributed transmission; and
a second rank is associated with the enhanced PDCCH of a localized transmission.

59. The method of claim 31, further comprising:
receiving channel state information (CSI) feedback from the UE regarding the enhanced PDCCH separate from a feedback provided for data transmission on a downlink communication channel.

60. The method of claim 59, wherein receiving the CSI feedback comprises receiving the CSI feedback on an existing channel that provides a feedback for data transmission.

61. An apparatus for wireless communications by a user equipment (UE), comprising:
means for determining a transmission rank for an enhanced physical downlink control channel (PDCCH) transmission;
means for determining one or more antenna ports used for the enhanced PDCCH;
means for determining a rate matching scheme for the enhanced PDCCH, wherein rate matching is performed around at least one of a channel state information reference signal (CSI-RS) or a common reference signal (CRS); and
means for processing the enhanced PDCCH transmitted in accordance with the determined transmission rank, the determined one or more antenna ports, and the determined rate matching scheme.

62. The apparatus of claim 61, wherein the one or more antenna ports are determined based, at least in part, on the determined transmission rank.

63. The apparatus of claim 61, wherein the one or more antenna ports are determined based, at least in part, as a function of an identification of the UE.

64. The apparatus of claim 61, wherein the one or more antenna ports are determined based on at least one of: a downlink control information (DCI) format or a received radio resource control signaling.

65. The apparatus of claim 61, wherein the rate matching comprises:
rate matching around common reference signals (CRS) of a serving cell.

66. The apparatus of claim 61, wherein the rate matching comprises:
rate matching around CSI-RS configured for the UE.

67. The apparatus of claim 61, wherein the rate matching comprises:
rate matching around common reference signals (CRS) of one or more neighboring cells.

68. The apparatus of claim 61, wherein:
a first modulation scheme is associated with a first decoding candidate for the enhanced PDCCH in a first subframe; and
a second modulation scheme is associated with a second decoding candidate for the enhanced PDCCH in a second subframe.

69. The apparatus of claim 68, wherein the first subframe and the second subframe are the same.

70. The apparatus of claim 61, further comprising means for configuring two or more sets of resources for the enhanced PDCCH, and wherein the modulation scheme further depends on the set of resources associated with the enhanced PDCCH.

71. The apparatus of claim 61, wherein:
a first modulation scheme is associated with the enhanced PDCCH for a unicast transmission; and
a second modulation scheme is associated with the enhanced PDCCH for a broadcast or multicast transmission.

72. The apparatus of claim 61, wherein:
a first modulation scheme is associated with the enhanced PDCCH of a distributed transmission; and
a second modulation scheme is associated with the enhanced PDCCH of a localized transmission.

73. The apparatus of claim 61, wherein:
a first rank is associated with a first decoding candidate for the enhanced PDCCH in a first subframe; and
a second rank is associated with a second decoding candidate for the enhanced PDCCH in a second subframe.

74. The apparatus of claim 61, further comprising configuring two or more sets of resources for the enhanced PDCCH, and wherein the rank further depends on the set of resources associated with the enhanced PDCCH.

75. The apparatus of claim 61, wherein:
a first rank is associated with the enhanced PDCCH for a unicast transmission; and
a second rank is associated with the enhanced PDCCH for a broadcast or multicast transmission.

76. The apparatus of claim 61, wherein:
a first rank is associated with the enhanced PDCCH of a distributed transmission; and
a second rank is associated with the enhanced PDCCH of a localized transmission.

77. An apparatus for wireless communications by a base station, comprising:
means for determining a transmission rank for an enhanced physical downlink control channel (PDCCH) transmission;
means for determining one or more antenna ports used for the enhanced PDCCH transmission;
means for determining a rate matching scheme for the enhanced PDCCH, wherein rate matching is performed around at least one of a channel state information reference signal (CSI-RS) or a common reference signal (CRS); and
means for transmitting the enhanced PDCCH to a user equipment (UE) in accordance with the determined transmission rank, the determined one or more antenna ports, and the determined rate matching scheme.

78. The apparatus of claim 77, wherein the one or more antenna ports are determined based, at least in part, on the determined transmission rank.

79. The apparatus of claim 77, wherein the one or more antenna ports are determined based, at least in part, as a function of an identification of the UE.

80. The apparatus of claim 77, wherein the one or more antenna ports are determined based on at least one of: a downlink control information (DCI) format or a received radio resource control signaling.

81. The apparatus of claim 77, wherein the rate matching comprises:
rate matching around common reference signals (CRS) of a serving cell.

82. The apparatus of claim 77, wherein the rate matching comprises:
rate matching around CSI-RS configured for the UE.

83. The apparatus of claim 77, wherein the rate matching comprises:
rate matching around common reference signals (CRS) of one or more neighboring cells.

84. The apparatus of claim 77, wherein:
a first modulation scheme is associated with a first decoding candidate for the enhanced PDCCH in a first subframe; and
a second modulation scheme is associated with a second decoding candidate for the enhanced PDCCH in a second subframe.

85. The apparatus of claim 84, wherein the first subframe and the second subframe are the same.

86. The apparatus of claim 77, further comprising means for configuring two or more sets of resources for the enhanced PDCCH, and wherein the modulation scheme further depends on the set of resources associated with the enhanced PDCCH.

87. The apparatus of claim 77, wherein:
a first modulation scheme is associated with the enhanced PDCCH for a unicast transmission; and
a second modulation scheme is associated with the enhanced PDCCH for a broadcast or multicast transmission.

88. The apparatus of claim 77, wherein:
a first modulation scheme is associated with the enhanced PDCCH of a distributed transmission; and
a second modulation scheme is associated with the enhanced PDCCH of a localized transmission.

89. The apparatus of claim 77, wherein:
a first rank is associated with a first decoding candidate for the enhanced PDCCH in a first subframe; and
a second rank is associated with a second decoding candidate for the enhanced PDCCH in a second subframe.

90. The apparatus of claim 77, further comprising configuring two or more sets of resources for the enhanced PDCCH, and wherein the rank further depends on the set of resources associated with the enhanced PDCCH.

91. The apparatus of claim 77, wherein:
a first rank is associated with the enhanced PDCCH for a unicast transmission; and
a second rank is associated with the enhanced PDCCH for a broadcast or multicast transmission.

92. The apparatus of claim 77, wherein:
a first rank is associated with the enhanced PDCCH of a distributed transmission; and
a second rank is associated with the enhanced PDCCH of a localized transmission.

93. An apparatus for wireless communications by a user equipment (UE), comprising:
at least one processor configured to determine a transmission rank for an enhanced physical downlink control channel (PDCCH) transmission, determine one or more antenna ports used for the enhanced PDCCH, determine a rate matching scheme for the enhanced PDCCH, wherein rate matching is performed around at least one of a channel state information reference signal (CSI-RS) or a common reference signal (CRS), and process the enhanced PDCCH transmitted in accordance with the determined transmission rank, the determined one or more antenna ports, and the determined rate matching scheme; and
a memory coupled with the at least one processor.

94. An apparatus for wireless communications by a base station, comprising:
at least one processor configured to determine a transmission rank for an enhanced physical downlink control channel (PDCCH) transmission, determine one or more antenna ports used for the enhanced PDCCH transmission; determine a rate matching scheme for the enhanced PDCCH, wherein rate matching is performed around at least one of a channel state information reference signal (CSI-RS) or a common reference signal (CRS), and transmit the enhanced PDCCH to a user equipment (UE) in accordance with the determined transmission rank, the determined one or more antenna ports, and the determined rate matching scheme; and
a memory coupled with the at least one processor.

95. A computer program product for wireless communications by a user equipment (UE) comprising a computer readable medium having instructions stored thereon, the instructions executable by one or more processors for:
determining a transmission rank for an enhanced physical downlink control channel (PDCCH) transmission;
determining one or more antenna ports used for the enhanced PDCCH;
determining a rate matching scheme for the enhanced PDCCH, wherein rate matching is performed around at least one of a channel state information reference signal (CSI-RS) or a common reference signal (CRS); and
processing the enhanced PDCCH transmitted in accordance with the determined transmission rank, the determined one or more antenna ports, and the determined rate matching scheme.

96. A computer program product for wireless communications by a base station comprising a computer readable medium having instructions stored thereon, the instructions executable by one or more processors for:
determining a transmission rank for an enhanced physical downlink control channel (PDCCH) transmission;
determining one or more antenna ports used for the enhanced PDCCH transmission;
determining a rate matching scheme for the enhanced PDCCH, wherein rate matching is performed around at least one of a channel state information reference signal (CSI-RS) or a common reference signal (CRS); and
transmitting the enhanced PDCCH to a user equipment (UE) in accordance with the determined transmission rank, the determined one or more antenna ports, and the determined rate matching scheme.
